(19) United States
(12) Patent Application Publication
(10) Pub. No.: US 2025/0201887 A1
(43) Pub. Date: Jun. 19, 2025

(54) FUEL CELL OR ELECTROLYZE STRUCTURE

(71) Applicant: L'Air Liquide, Societe Anonyme pour l'Etude et l’Exploitation des Procedes Georges Claude, Paris (FR)

(72) Inventors: Denis SIRAC, Sassenage (FR); Johan ANDRE, Sassenage (FR)

(21) Appl. No.: 18/849,590

(22) PCT Filed: Mar. 17, 2023
(86) PCT No.: PCT/EP2023/056852

§ 371 Date: Sep. 23, 2024

(30) Foreign Application Priority Data
Mar. 23, 2022 (FR) FR 2202561

(51) Int. Cl. H01M 8/248; C25B 9/77; H01M 8/10; H01M 8/241

(52) U.S. Cl. CPC H01M 8/248; C25B 9/77; H01M 8/241; H01M 2008/1095

(57) ABSTRACT

The invention relates to a proton-exchange membrane fuel cell comprising a stack of a plurality of cells, the stack being sandwiched between a first clamping plate and a second clamping plate in order to apply a predetermined clamping pressure to the stack, one of the clamping plates comprising at least one tapered seat leading into a through-hole, the stack comprising at least one clamping device that comprises a tie rod and a tapered washer received by the tapered seat in such a way that the tapered portions are facing one another, the tie rod being held in position by a first of its ends by the tapered washer so as to apply a clamping pressure to the stack.

### CROSS REFERENCE TO RELATED APPLICATIONS

This application is a § 371 of International PCT Application PCT/EP2023/056852, filed Mar. 17, 2023, which claims the benefit of FR2202561, filed Mar. 23, 2022, both of which are herein incorporated by reference in their entireties.

### FIELD OF THE INVENTION

The present invention relates to a fuel cell, notably of the proton-exchange membrane (PEMFC) type, structure or electrolyzer structure, comprising a stack of elementary cells, the cells each comprising an anode plate and a cathode plate sandwiching a membrane electrode assembly (MEA).

### BACKGROUND OF THE INVENTION

In such a structure, the stack is sandwiched between two clamping plates so as to apply a determined clamping pressure to the stack, at least one end of the stack comprising an electrically conductive current collector plate electrically connected to the cells of the stack so as to collect the sum of the electric currents produced by the cells. A tie rod serves to maintain the clamping of such a stack.

Such a tie rod may buckle when the structure is subjected to vibrations. Furthermore, when the tie rod is covered by insulation, the latter may wear when the structure is subjected to these vibrations or when it is subjected to shocks. Lastly, the tie rod may generate a short circuit between the tie rod and the cells when it is not correctly centered with respect to the openings provided in the cells.

Documents JP 2006 040713A, US 2021/202974A1 and CN 105 552 422B each describe a fuel cell stack comprising a plurality of cells.

### SUMMARY OF THE INVENTION

In certain embodiments, the present invention aims to effectively remedy these drawbacks by proposing a proton-exchange membrane fuel cell having a stack of a plurality of cells, the stack being sandwiched between a first clamping plate and a second clamping plate so as to apply a predetermined clamping pressure to the stack, one of the clamping plates having at least one tapered bearing surface opening out into a through-hole, the fuel cell having at least one clamping device having a tie rod and a tapered washer received by the tapered bearing surface such that the tapered parts are facing, the tie rod being held in position by a first of its ends by the tapered washer so as to apply the clamping pressure to the stack.

Such an arrangement enables automatic realignment of the stack in the event of shock or vibration. This makes it possible to avoid any short-circuiting between the tie rod and the openings provided in the cells, for passage of the tie rod. Furthermore, when the tie rod is covered by thermal and/or electrical insulation, the wear of the latter is reduced, by virtue of the gap which is permanently between the through-hole and the tie rod.

Lastly, such an arrangement enables uniform clamping of the stack, thus making it possible to avoid a breakage of the tie rod when the fuel cell is subjected to vibrations.

According to one embodiment, the tapered bearing surface and the tapered washer are arranged such that there is a gap, notably a circular ring, between the tie rod and the through-hole in the tapered washer.

According to one embodiment, the tapered bearing surface and the tapered washer are arranged such that there is permanently a gap all the way around the tie rod, between the tie rod and the through-hole in the tapered washer.

According to one embodiment, the tie rod passes all the way through the tapered washer.

Such an arrangement facilitates the mounting of the fuel cell.

According to one embodiment, the tapered bearing surface is provided on that face of the clamping plate which is opposite the stack.

According to one embodiment, the clamping device has a nut screwed onto the tie rod so as to clamp the tapered washer against said clamping plate or the clamping device has a compensation member for compensating for the dimensional change due to the cells of the stack, the compensation member notably having a spring disposed around the tie rod, the compensation member being disposed axially between the tapered washer and an end-of-travel member, in order to allow the compensation member to bring about a relative movement of the end-of-travel member with respect to the tapered washer.

In a variant, the tapered washer has a tapping and the tapered washer is screwed onto the tie rod.

According to one embodiment, the end-of-travel member has a tapping and is screwed onto the tie rod.

According to one embodiment, the tie rod is held at its ends by a flat of the tapered washer and by a flat of the end-of-travel member.

According to one embodiment, the compensation member is arranged so as to maintain a clearance between the tapered washer and the end-of-travel member.

According to one embodiment, the clamping device has, on the side of the other of the clamping plates, a nut screwed onto the tie rod so as to apply a clamping force to the other of the clamping plates, or a tapping provided in the other of the clamping plates so as to receive a second of the ends, notably a threaded end, of the tie rod.

In a variant, the other of the clamping plates has at least one tapered bearing surface opening out into a through-hole, the clamping device having at least two tapered washers, each washer being received respectively by the tapered bearing surface of the one and the other of the clamping plates, the tie rod being held in position at each of its ends by the tapered washers so as to apply the clamping pressure to the stack.

According to one embodiment, each cell has an opening for passage of the tie rod, the diameter of the opening being strictly greater than the inner diameter of the tapered washer.

According to one embodiment, the ratio of the diameter of the orifice to the inner diameter of the tapered washer is predetermined so as to avoid contact between the tie rod and the cells after centering of the tie rod, the ratio notably being greater than 1.3, for example greater than 1.8.

According to one embodiment, the inner diameter of the tapered washer at one end of the tie rod is strictly smaller than the inner diameter of the tapered washer at another end of the tie rod.

Such an arrangement enables the installation of a compensation member.

According to one embodiment, the clamping device has a plurality of tie rods.

According to one embodiment, each tie rod is held in position by at least one tapered washer, notably by two tapered washers.

According to one embodiment, the tie rod has no thermal and/or electrical insulation along the stack, notably around the perimeter of the tie rod.

In a variant, the tie rod has thermal and/or electrical insulation around its perimeter.

In such a case, the invention makes it possible to avoid wear of the insulation, by virtue of the gap which is permanently between the through-hole and the tie rod, therefore between the openings in the cells and the tie rods.

According to one embodiment, the tapered bearing surface has a surface extending around the entire perimeter of the through-hole, the surface notably having a cone frustum exhibiting symmetry of revolution.

Such a tapered bearing surface enables good clamping while limiting the risks of damage to the clamping plate.

According to one embodiment, the surface of the tapered bearing surface has a portion in contact with the tapered washer.

According to one embodiment, the fuel cell has no electrical insulation between the tapered washer and the tapered bearing surface.

According to one embodiment, the through-hole opens out out of the clamping plate, solely through the lateral faces of the clamping plate, for passage of the tie rod.

According to one embodiment, the plurality of cells has a first cell at a first end of the stack and a last cell at a second end of the stack, each cell of the plurality having an anode plate and a cathode plate sandwiching a membrane electrode assembly.

According to one embodiment, one of the plates of the first cell forms, with one of the plates of another of the cells, a first inter-cell cooling circuit, the other of the plates of the first cell defining a first end plate, one of the plates of the last cell forming, with one of the plates of another of the cells, a last inter-cell cooling circuit, the other of the plates of the last cell defining a last end plate.

According to one embodiment, the fuel cell has a distribution plate comprising a first electric current collection face intended to face a first electric current collection plate and a distribution face intended to face the cooling face of the first end plate.

According to one embodiment, the distribution manifold is arranged such that all of the fluid entering the distribution manifold passes through the thickness of the distribution plate in order to distribute the fluid in the first cell.

According to one embodiment, the distribution plate has six distribution manifolds, notably in order to distribute or collect a fuel, an oxidant and a cooling fluid.

According to one embodiment, each anode plate or cathode plate comprises a reactive face and a cooling face opposite one another, the reactive face of each plate being intended to face the membrane electrode assembly and being provided with relief elements and hollows forming a reactant circuit for the circulation of a reactant fluid, the cooling face of the cathode plate of at least one of the cells being intended to face the cooling face of the anode plate of another of the cells, defining between them relief elements and hollows so as to form an inter-cell cooling circuit for the circulation of a cooling fluid.

According to one embodiment, each cathode plate or anode plate has a reactant inlet manifold formed through the plate and in fluidic communication with the reactant circuit, a reactant outlet manifold formed through the plate and in fluidic communication with the reactant circuit, a cooling fluid inlet manifold formed through the plate, and a cooling fluid outlet manifold formed through the plate.

According to one embodiment, the fuel cell has a closure plate comprising a second electric current collection face intended to face a second electric current collection plate and a closure face fastened to the cooling face of the last end plate, the closure face and the cooling face of the last end plate defining between them relief elements and hollows so as to form a last cooling circuit for the circulation of the cooling fluid.

According to one embodiment, the fuel cell is intended to be powered by hydrogen.

The invention also relates to an electrolyzer, having a stack of a plurality of cells, the stack being sandwiched between a first clamping plate and a second clamping plate so as to apply a predetermined clamping pressure to the stack, one of the clamping plates having at least one tapered bearing surface opening out into a through-hole, the electrolyzer having at least one clamping device having a tie rod and a tapered washer received by the tapered bearing surface such that the tapered parts are facing, the tie rod being held in position by a first of its ends by the tapered washer so as to apply the clamping pressure to the stack.

According to one embodiment, the electrolyzer is intended to produce hydrogen.

The features relating to the fuel cell are applicable individually or in combination to the electrolyzer.

The invention lastly relates to a proton-exchange membrane fuel cell structure or electrolyzer structure, the structure having a stack of a plurality of cells, the stack being sandwiched between a first clamping plate and a second clamping plate so as to apply a predetermined clamping pressure to the stack, one of the clamping plates having at least one tapered bearing surface opening out into a through-hole, the structure having at least one clamping device having a tie rod and a tapered washer received by the tapered bearing surface such that the tapered parts are facing, the tie rod being held in position by a first of its ends by the tapered washer so as to apply the clamping pressure to the stack.

The features relating to the fuel cell are applicable individually or in combination to this structure.

According to one embodiment, the structure is a fuel cell structure intended to be powered by hydrogen or an electrolyzer structure intended to produce hydrogen.

### BRIEF DESCRIPTION OF THE DRAWINGS

The invention will be better understood from reading the description below and from studying the figures. These figures are given only by way of illustration and do not in any way limit the invention.

FIG. 1 is a schematic representation in section of a fuel cell according to the invention;

FIG. 2 is a schematic representation in section of a fuel cell according to the invention:

FIG. 3 is a schematic representation in section of the fuel cell in FIG. 1 or in FIG. 2; and

FIG. 4 is a schematic representation in elevation of the fuel cell in FIG. 3.

### DETAILED DESCRIPTION OF THE INVENTION

Those elements which are identical, similar or analogous keep the same reference from one figure to the next.

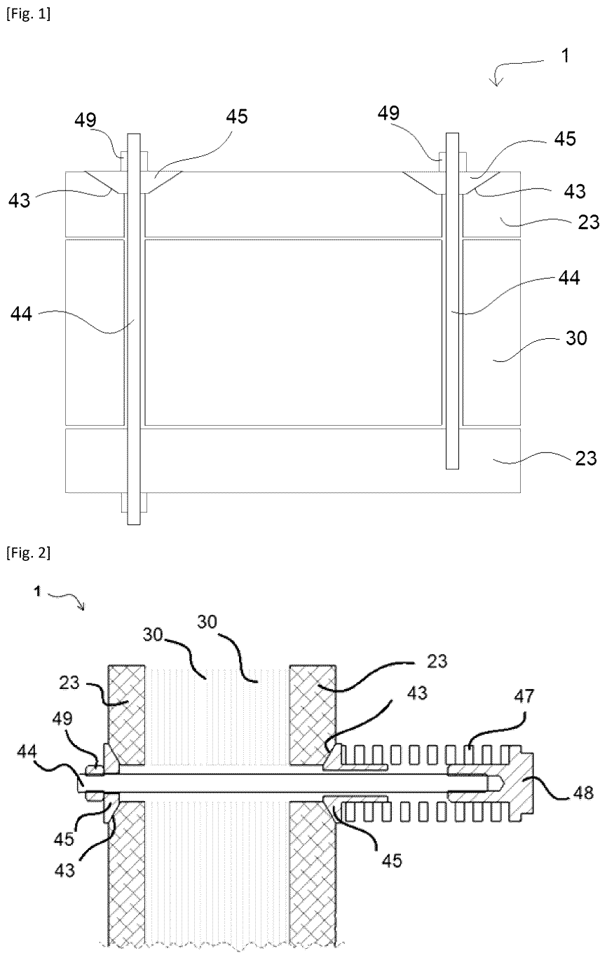

As can be seen in FIG. 1, a proton-exchange membrane fuel cell 1

has a stack of a plurality of cells 30. The stack is sandwiched between a first clamping plate 23 and a second clamping plate 23 so as to apply a predetermined clamping pressure to the stack. The first clamping plate 23 has two tapered bearing surfaces 43 each opening out into a through-hole.

Each tapered bearing surface 43 is provided on that face of the first clamping plate 23 which is opposite the stack.

The fuel cell 1 has at least one clamping device having in this case two tie rods 44 and two tapered washers 45.

Each tapered washer 45 is received by one of the tapered bearing surfaces 43 such that the tapered parts of the washer and of the tapered bearing surface are facing and in contact.

Each tie rod 44 is mounted by one of its ends in one of the tapered washers 45 and by another of its ends either in a nut (the tie rod on the left in FIG. 1) or in a tapping provided in the clamping plate 23 (the tie rod on the right in FIG. 1).

Each tie rod 44 passes all the way through each of the two tapered washers 45 and a nut 49 is screwed onto a threaded end of the tie rod, in order to effect the clamping of the fuel cell, the nut 49 coming into abutment against the tapered washer 45.

FIG. 2 illustrates a fuel cell identical to the one in FIG. 1, but in which a tie rod held in position by two tapered washers is shown.

The first clamping plate 23 and the second clamping plate 23 each have a tapered bearing surface 43 opening out into a through-hole and the clamping device has two tapered washers 45.

The tapered washer 45 on the side of the first plate 23 is received by the tapered bearing surface 43 of the first plate such that the tapered parts are facing.

The tapered washer 45 on the side of the second plate 23 is received by the tapered bearing surface 43 of the second plate such that the tapered parts are facing.

The tie rod 44 is accommodated between the two tapered washers 45 so as to apply the clamping pressure to the stack.

The tie rod 44 passes all the way through each of the two tapered washers 45.

As can be seen in FIG. 2, the clamping device also has a compensation member 47 for compensating for the dimensional change due to the cells 30 of the stack.

Although not shown in FIG. 1, such a compensation member 47 may be installed at the tapered washer 45 of one of the tie rods or of each tie rod of the fuel cell in FIG. 1.

The compensation member 47 has a spring 47 disposed at a first end of the tie rod 44, between the tapered washer 45 and an end-of-travel member 48.

The compensation member 47 is mounted around the tie rod 44, the tie rod 44 being held at its ends by a flat of the tapered washer 45 and by a flat of the end-of-travel member 48. In the example shown in FIG. 2, the end-of-travel member 48 has a tapping and is screwed onto a threaded end of the tie rod 44.

The clamping device has a nut 49 screwed onto the other end of the tie rod 44, the nut 49 coming into contact with one of the tapered washers 45.

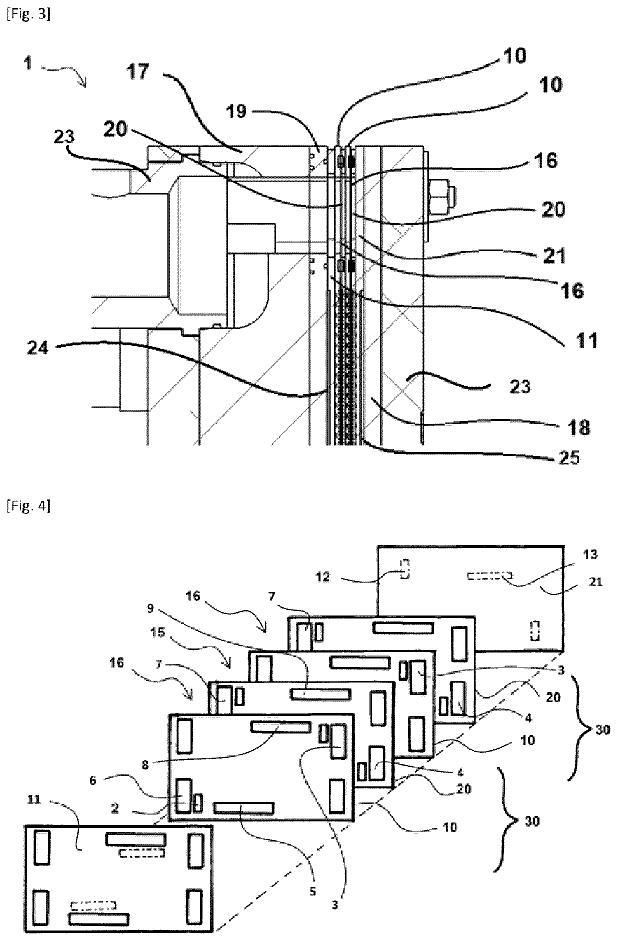

As can be seen in FIG. 3, the plurality of cells 30 has a first cell 30 at a first end of the stack and a last cell 30 at a second end of the stack.

Each cell 30 of the plurality has an anode plate 10 and a cathode plate 20 sandwiching a membrane electrode assembly 16, one of the plates 10, 20 of the first cell 30 forming, with one of the plates 10, 20 of another of the cells 30, a first inter-cell cooling circuit 15, the other of the plates 10, 20 of the first cell 30 defining a first end plate, one of the plates 10, 20 of the last cell 30 forming, with one of the plates 10, 20 of another of the cells 30, a last inter-cell cooling circuit 15, the other of the plates 10, 20 of the last cell 30 defining a last end plate.

The fuel cell 1 has a distribution plate 11 comprising a first electric current collection face intended to face a first electric current collection plate 24 and a distribution face intended to face the cooling face of the first end plate.

The fuel cell 1 has a first seal 19 interposed between the distribution plate 11 and the first clamping plate 17, 23, the distribution plate 11 having at least one fluid distribution manifold formed through the plate, the first electric current collection face and/or the first clamping plate 17, 23 having an annular lip provided around the distribution manifold, so as to squeeze the first seal 19 in order to ensure tightness with respect to the fluid.

The first electric current collection face has a first boss for receiving the first collection plate 24, such that the distribution plate 11 and the first collection plate 24 together form a planar face for coming into contact with the first seal 19.

The first seal 19 has at least one through-hole for passage of the tie rod.

The fuel cell 1 has a closure plate 21 comprising a second electric current collection face intended to face a second electric current collection plate 25 and a closure face fastened to the cooling face of the last end plate, the closure face and the cooling face of the last end plate defining between them relief elements and hollows so as to form a last cooling circuit for the circulation of the cooling fluid.

The fuel cell 1 has a second seal 18 interposed between the second collection plate 25 and the second clamping plate 23.

FIG. 4 shows the fuel cell 1 in elevation, before assembly.

As can be seen in FIG. 4, each plate 10, 20 has:
a reactant inlet manifold 3, 4 formed through the plate 10, 20 and in fluidic communication with the reactant circuit via a first aperture 2 formed through the plate 10, 20;
a reactant outlet manifold 6, 7 formed through the plate 10, 20 and in fluidic communication with the reactant circuit via a second aperture 2 formed through the plate 10, 20;
a cooling fluid inlet manifold 5 formed through the plate 10, 20;
a cooling fluid outlet manifold 8, 9 formed through the plate 10, 20:
at least two orifices formed through the plate 10, 20, each orifice being arranged so as to allow fluidic communication only through the plate 10, 20, without being in fluidic communication with the reactant circuit.

The reactant inlet manifold 3 of an anode plate 10 is in fluidic communication with one of the orifices of a cathode plate 20 and the reactant outlet manifold 6 of the anode plate 10 is in fluidic communication with another of the orifices of the cathode plate 20.

The reactant inlet manifold 3 of a cathode plate 20 is in fluidic communication with one of the orifices of an anode plate 10 and the reactant outlet manifold 6 of the cathode plate 20 is in fluidic communication with another of the orifices of the anode plate 10.

Thus, the stack allows distribution of the reactant fluid intended for the anode plates 10 and distribution of the reactant fluid intended for the cathode plates 20 by forming two independent circuits.

The closure face of the closure plate 21 has a reactant passage 12, 13 formed by relief elements and hollows, in order to allow fluidic communication between the reactant inlet manifold 3, 4 and the reactant circuit or in order to allow fluidic communication between the reactant outlet manifold 6, 7 and the reactant circuit.

The closure face of the closure plate 21 has a cooling passage 13 formed by relief elements and hollows, in order to allow fluidic communication between the cooling fluid inlet manifold 5 and the cooling circuit, or in order to allow fluidic communication between the cooling fluid outlet manifold 8, 9 and the cooling circuit.

The reactant passage 12, 13 and the cooling passage 13 may be provided on the closure face, on the last end plate, or on both of these.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1-11. (canceled)

12. A structure of a proton-exchange membrane fuel cell or electrolyzer, the structure comprising:
a stack of a plurality of cells, the stack being sandwiched between a first clamping plate and a second clamping plate so as to apply a predetermined clamping pressure to the stack, one of the clamping plates having at least one tapered bearing surface opening out into a through-hole; and
at least one clamping device having a tie rod and a tapered washer received by the at least one tapered bearing surface such that the tapered parts are facing, the tie rod being held in position by a first end by the tapered washer so as to apply the clamping pressure to the stack.

13. The structure as claimed in claim 12, the tie rod passing all the way through the tapered washer.

14. The structure as claimed in claim 12, the tapered bearing surface being provided on that face of said clamping plate which is opposite the stack.

15. The structure as claimed in claim 12, the clamping device having a nut screwed onto the tie rod so as to clamp the tapered washer against said clamping plate or the clamping device having a compensation member for compensating for the dimensional change due to the cells of the stack, the compensation member notably having a spring disposed around the tie rod, the compensation member being disposed axially between the tapered washer and an end-of-travel member, in order to allow the compensation member to bring about a relative movement of the end-of-travel member with respect to the tapered washer.

16. The structure as claimed in claim 15, the end-of-travel member having a tapping and being screwed onto the tie rod.

17. The structure as claimed in claim 12, the tie rod having no thermal and/or electrical insulation along the stack.

18. The structure as claimed in claim 12, the clamping device having, on the side of the other of the clamping plates, a nut screwed onto the tie rod so as to apply a clamping force to the other of the clamping plates, or a tapping provided in the other of the clamping plates so as to receive a second of the ends, notably a threaded end, of the tie rod.

19. The structure as claimed in claim 12, the other of the clamping plates having at least one tapered bearing surface opening out into a through-hole, the clamping device having at least two tapered washers, each washer being received respectively by the tapered bearing surface of the one and the other of the clamping plates, the tie rod being held in position at each of its ends by the tapered washers so as to apply the clamping pressure to the stack.

20. The structure as claimed in claim 12, each cell having an opening for passage of the tie rod, the diameter of the opening being strictly greater than the inner diameter of the tapered washer.

21. A proton-exchange membrane fuel cell having the structure as claimed in claim 12.

22. An electrolyzer having the structure as claimed in claim 12.
